(19) United States
(12) Patent Application Publication
(10) Pub. No.: US 2021/0264533 A1
(43) Pub. Date: Aug. 26, 2021

(54) MESSAGE NOTIFICATION AND FEEDBACK SYSTEM FOR INSURANCE CLAIM PROCESSING

(71) Applicant: STATE FARM MUTUAL AUTOMOBILE INSURANCE COMPANY, Bloomington, IL (US)

(72) Inventors: Andrew J. Feit, Normal, IL (US); Scott E. Lackey, Bloomington, IL (US); Christina M. Boring, Bloomington, IL (US); Katrina Weisiger, Bloomington, IL (US); Erin Josephine Jacoby Easter, Bloomington, IL (US); David Kuriyan Schuster, Bloomington, IL (US); Chadd Eugene Grove, Bloomington, IL (US); Diane Michele Hrabik, Bloomington, IL (US); Tracy Elaine Jones, Normal, IL (US)

(21) Appl. No.: 16/668,951

(22) Filed: Oct. 30, 2019

Related U.S. Application Data
(63) Continuation of application No. 14/979,881, filed on Dec. 28, 2015, now abandoned.
(60) Provisional application No. 62/109,241, filed on Jan. 29, 2015.
(60) Provisional application No. 62/098,572, filed on Dec. 31, 2014.

(51) Int. Cl. G06Q 40/08

(52) U.S. Cl. CPC G06Q 40/08

(57) ABSTRACT

The present embodiments relate to enhancing the online customer experience and handling of auto, home, and/or other insurance claims. A website and/or graphical user interface may offer customers clear instruction on what is needed from them to process their claim. An online self-service channel may allow an insurance customer to access claim status information. The online self-service channel may provide “My Action Items” list functionality for customers, such that they become aware of pending items on their claim(s) which require action on their part to expedite the claim process, such as uploading photos, forms, or receipts. The actions items may be automatically created, such as by a server or electronic claim system tracking the progress of an insurance claim. The self-service channel may include an indication that the customer has completed the action item, and an indication that the insurance provider has confirmed the completion of the customer's action item.

### CROSS REFERENCE TO RELATED APPLICATIONS

This application claims the benefit of U.S. Provisional Patent Application No. 62/098,572, entitled “Message Notification and Feedback System for Insurance Underwriting,” filed Dec. 31, 2014; U.S. Provisional Patent Application No. 62/109,241, entitled “Message Notification and Feedback System for Insurance Claim Processing,” filed Jan. 29, 2015; and U.S. patent application Ser. No. 14/979,881, entitled “Message Notification and Feedback Systems for Insurance Claim Processing,” filed Jan. 28, 2015, the disclosure of each of which is hereby expressly incorporated by reference herein in its entirety.

### FIELD OF THE DISCLOSURE

The present disclosure relates to systems, methods, apparatus, and non-transitory computer readable media for providing information regarding an insurance claim process and, more particularly, to providing reminders and feedback to customers regarding claim data used throughout an insurance claim process.

### BACKGROUND

Traditionally, when a customer submits an insurance claim, a claim handling (or claim assessment) process is used to allow an insurer to evaluate the potential monetary value to be paid for the claim and/or to determine whether the claim falls under one or more uncovered insurance policy provisions. To facilitate this process, an insurer may collect information related to fraud prevention, receipts from the customer for reimbursements, medical record data, pictures and/or video used to assess property damage, etc.

Some of the information used throughout the claim assessment process may be needed from the customer, which may be referred to as customer “action items.” Traditionally, these action items may be communicated verbally and/or mailed to the customer by the insurer, which may be manually tracked by an insurance staff member as the completed action items are confirmed. However, this may result in the claim assessment process being time-consuming and arduous, as manual confirmation is required regarding whether the customer has submitted the required information.

As a result, providing an automated notification and feedback system for insurance claim “action item” and status may be useful but presents several challenges.

### BRIEF SUMMARY

Aspects are disclosed to generate a “My Action Items” list functionality for customers so they are aware of pending items on one or more open claims that may require action on their part to expedite the claim process. Various aspects are disclosed regarding automated item creation, manual item creation, tracing item completion (e.g., when the customer completed the action and when the item was received by insurer), providing URL links to any online accessible action items, generating reminder notifications, and sending reminder notifications related to the action items to the customer.

The present aspects relate to an action item generation system that facilitates the creation and management of one or more action items associated with an insurance claim. The present aspects may also include creating reminder notifications regarding outstanding action items and/or providing access to claim status based upon the action items that may still need to be completed. The action item generation system may (1) receive a first indication of an insurance claim being opened; (2) generate one or more action items to be completed in response to the first indication, the one or more action items being based upon the type of insurance claim used for claim assessment; (3) send a reminder notification to a computing device indicative of the one or more action items to be completed; (4) receive a second indication of an action item from the one or more action items being completed; and/or (5) update an insurer profile indicating which of the one or more action items still need to be completed based upon the second indication to generate an updated insurer profile to facilitate timely insurance claim handling and processing. The updated insurer profile may be accessed via the computing device to indicate information regarding status of the claim. The system may include additional, fewer, or alternate components, including those discussed elsewhere herein.

In one aspect, a computer-implemented method for maintaining an up-to-date insurer profile associated with an insurance policy may be provided. The method may include (1) receiving, by one or more processors, a first indication of an insurance claim being opened; (2) generating, by one or more processors, one or more action items to be completed in response to the first indication, the one or more action items being based upon the type of insurance claim used for claim assessment; (3) sending, by one or more processors, a reminder notification to a computing device indicative of the one or more action items to be completed; (4) receiving, by one or more processors, a second indication of an action item from the one or more action items being completed; and/or (5) updating, by one or more processors, an insurer profile indicating which of the one or more action items still need to be completed based upon the second indication to generate an updated insurer profile to facilitate prompt insurance claim processing. The updated insurer profile may be accessed via the computing device to indicate information regarding status of the claim. The method may include additional, fewer, or alternate components, including those discussed elsewhere herein.

### BRIEF DESCRIPTION OF THE DRAWINGS

The Figures described below depict various aspects of the system and methods disclosed herein. It should be understood that each Figure depicts an aspect of a particular aspect of the disclosed system and methods, and that each of the Figures is intended to accord with a possible aspect thereof. Further, wherever possible, the following description refers to the reference numerals included in the following Figures, in which features depicted in multiple Figures are designated with consistent reference numerals.

FIG. 1 is a block diagram of an exemplary action item generation system 100;

FIG. 2A is an exemplary screenshot 200 of an interactive email notification;

FIG. 2B is an exemplary screenshot 250 of an interactive customer application providing claim status feedback;

FIG. 3A is an exemplary screenshot 300 of an interactive insurer application facilitating the generation of action item reminder notifications;

FIG. 3B is an exemplary screenshot 350 of an interactive insurer application facilitating the sending of action item reminder notifications;

FIG. 4A is an exemplary screenshot 400 of an interactive customer application providing reminder notifications;

FIG. 4B is an exemplary screenshot 450 of an interactive customer application providing reminder a link to a form used to complete the action item;

FIG. 5 illustrates a flow diagram of an exemplary method 500 for maintaining an up-to-date insurer profile associated with an insurance policy;

FIG. 6 illustrates an exemplary user interface or screenshot 600 of an inbox associated with insurance claim reporting and processing;

FIG. 7 illustrates an exemplary user interface or screenshot 700 associated with providing an online claim status and/or claim progress bar;

FIG. 8 illustrates an exemplary user interface or screenshot 800 of an inbox associated with insurance claim reporting and processing; and

FIG. 9 illustrates an exemplary user interface or screenshot 900 associated with an insurance claim and claim process summary, and claim toolkit.

### DETAILED DESCRIPTION

The present embodiments relate to, inter alia, enhancing the online customer experience and handling insurance claims, such as auto, home, renters, health, and/or life insurance claims. A system and method may provide a website and/or graphical user interface that may offer customers clear instruction on what is needed from them in order to process their insurance claim. An online self-service channel may allow an insurance customer to access insurance claim status information. The online self-service channel may provide “My Action Items” list functionality for customers, such that they are, or become, aware of pending items on their claim(s) which require action on their part to expedite the claim process. The present embodiments include capabilities for automated and/or manual creation of these action items. This functionality may also include an indication that the customer has completed the action item and the indication that the insurance provider has confirmed the completion of the customer's action item.

In addition, by proactively providing the “My Action Items” functionality to the customer, the amount of inbound and outbound calls to the insurance claim associates or representatives may be reduced. The functionality described herein also may assist insurance agents or representatives in servicing the customer by providing additional information to assist their customers.

The “My Action Items” functionality may provide the customer with a clear and concise explanation of what is expected of the customer, and/or address the unfamiliar nature of the customer's role in the claim process. It may also provide proactive messaging and claim status updates. This may allow an insurance provider to efficiently communicate with the customer on what is expected from the customer in order to promptly move the claim forward.

The “My Action Items” functionality may involve pending items that require action on the part of the customer to move claim process forward. In one embodiment, the action items may only include required items. Exemplary action items that a customer may be required to complete to process an insurance claim may include, but are not limited to: (1) sign and return Medical Authorization Form (which may include a brief description as to why this item is needed, for example, “A medical release that must be signed by the patient in order for insurance provider to obtain medical records”); (2) send in signed Power of Attorney documentation (which may include a brief description as to why this item is needed, for example, “This documentation is required if a POA is involved or the person acting on your behalf has a POA”); and/or (3) a personal property inventory reminder—for example, a message could be sent to remind the customer to complete personal property inventory. Additional, fewer, or alternate action items may be used, including those discussed elsewhere herein and/or detailed with respect to the Figures.

The “My Action Items” functionality may be supported by business rules. The business rules may be based upon or support (i) Free Form capabilities; (ii) predefined types of actions items can be selected; and/or (iii) an electronic claim system (which may include internet or intranet capabilities and/or user interfaces that include possible areas for creation: File Notes, Tasks, Possibly New Screens.

The “My Action Items” functionality may be associated with claims at a participant level in the electronic claim system. The functionality may include notifications of “My Action Items” to the customer, and/or customer messaging preferences should be used (via text, email, website or other push notifications).

Also, reminder notifications may be sent to the customer. Reminders may be automated messages sent to the customers on outstanding action items. Business rules may be defined on how the reminders on how these will be triggered. For example, how many days after the suggested time allotted does the reminder need to be generated. Customer messaging preferences may preferably be used (via text, email, “Pocket Agent” push notifications, other push notifications, such as via social media and/or the internet, etc.).

The functionality may also include follow-up notifications to claim associates. Business rules may also define how the follow-up notifications will be triggered. For example, if two automated reminders have been sent to the customer regarding an outstanding action item and no response from customer has been received, the electronic claim system may generate a follow-up notification to the claim associate.

The claim handling system may store and display created date and time; the due date and time; and/or user information (name and alias) for manually created action items. The claim handling system may display creation and completion information. URL links may be provided to any online accessible “My Action Items” when applicable (i.e., electronic reminder to customer). An URL link to the document/form needed, if applicable, may also be provided.

The “My Action Items” that are outstanding may be viewed or displayed within a graphical user interface. For instance, a Customer Claims Details Page may be provided and may be viewable or accessed by a customer, agent, and/or associate. A Customer Landing Page may also be provided; may be viewable or accessed by a customer, agent, and/or associate; and/or may be displayed by line of business, such as automobile insurance, home insurance, renters insurance, life insurance, health insurance, etc. The functionality may include new claim notification via email or paper mail sent to the customer; via mobile device; via insurance provider website; and/or via telephone, such as by insurance provider representative or claim associates. The claim associates may view a user interface that provides several features, including File Notes, File History, Tasks, and/or screens related to other functions.

Functionality may be provided to help a customer or claims associate manage “My Action Items.” For instance, an automated completion of the action item may be provided. The electronic claim system may mark an item as complete, then store completion date and time, and/or store user information for completed items.

Also, manual completion of the action item may be provided. Customers may manually mark an item as complete (such as by using a mouse). Claim associates may need to validate an activity completed by the customers. The electronic claim system may store the completion date and time, and/or store user information for completed items.

The ability to edit action items may also be provided. For instance, claim associates may edit customer name/description, may remove information, and/or edit from the electronic claim system. The electronic claim system may store date and time for edited action items; store user information for edited action items, and/or consider restricting access based upon manually created vs system created action items.

The functionality provided by the present embodiments may allow the “My Action Items” to be created, viewed, and managed. The customer may be able to view those items online and/or via an insurance provider website, such as by accessing the internet from their mobile device (smart phone, tablet, laptop, wearable electronics, phablet, smart watch, smart bracelet, or other computing device configured for wireless communication), and receive reminder notifications that those items are outstanding via e-mail, text, or push notifications. Insurance customers may also be able to manage those items by marking them complete via the internet and/or by accessing an insurance provider website.

Claim associates may be able to create, view, and/or manage the customer's “My Action Items” within an electronic or online claim system. The system/application will be able to automate some action items (Creation, Completion), while others may be manually created. An insurance agent may also be able to view their customers' “My Action Items” via the internet or insurance provider website.

The benefits of creating a “My Action Items” list may include: (1) meeting customer expectations by communicating what is needed from the customer; (2) providing assistance to the customer on how to complete an item and why the item is needed for the insurance claim; (3) providing an alternate channel to update customers on when action items need to be completed, aside from a phone call; and this may better satisfy customer communication preferences; (4) improve efficiency for business in communicating with the customer on what is expected from the customer; (5) potentially decrease incoming and outgoing phone calls needed to follow up with customer on the items; (6) may allow agents to be able to service their customers more efficiently because they may also have access to view the customers' “My Action Items”; (7) improves claim cycle time; and/or (8) increases customer engagement.

The “My Action Items” list functionality may make customers aware of pending items on their claim(s) which require action on their part to expedite the claim process. An application with capabilities for automated item creation, manual item creation, tracing item completion (when customer completed the action, when item was received by the insurance provider), providing URL links to any online accessible action items, and/or messaging related to action items (creation notification, reminders) may be provided.

The “My Action Items” functionality may provide customers with insight into tasks that may need to be completed for their claim to progress, providing customers with reminders when they need to perform an action. Within My Action Items, customers may be provided with more information that would help them complete a particular task/process or explain why it was necessary. Also, instead of making customers hunt for information about what they need to do, My Action Items would provide a few different methods for proactively conveying the necessary action/information to the user. My Action Items may provide a clear list of what the customer must do to help expedite the claim process. Claim tracker functionality may be provided that may provide a simple, high-level explanation of what customers should expect throughout the claim process.

### I. Exemplary Action Item Generation, Feedback, and Notification System

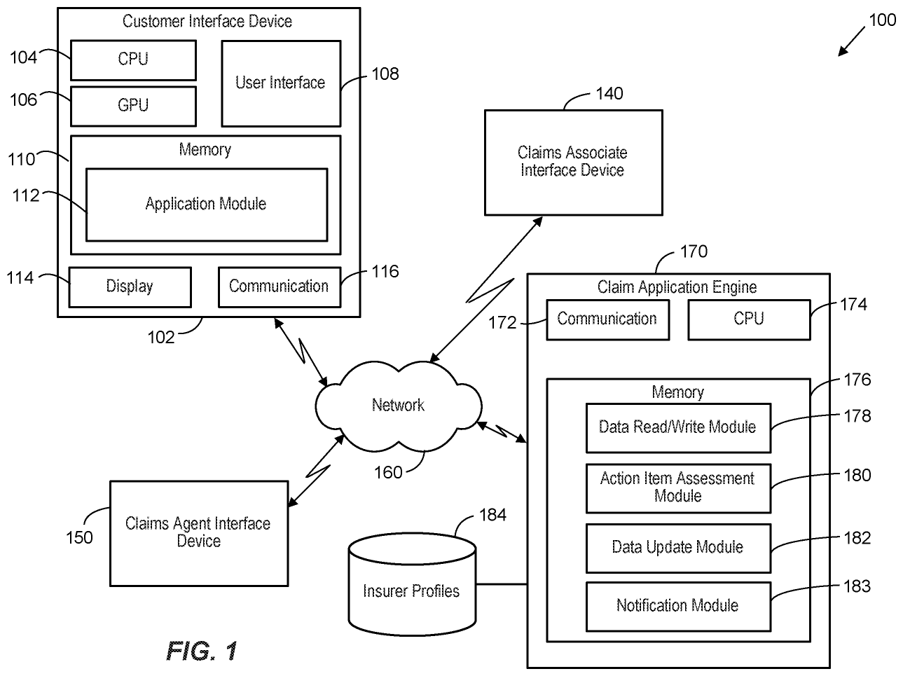

FIG. 1 is a block diagram of an exemplary action item generation system 100. Action item generation system 100 may include a customer interface device 102, a claims associate interface device 140, a claims agent interface device 150, and a claim application engine 170.

Customer interface device 102 may be configured to communicate with of client application engine 170 via network 160 to download, display, and/or facilitate updating information stored in insurer profiles database 184. Network 160 may include any appropriate combination of wired and/or wireless communication networks, web servers, etc., to facilitate this functionality. For example, network 160 may include any combination of a local area network (LAN), a metropolitan area network (MAN), a wide area network (WAN), public switched telephone networks (PSTN), and may facilitate a connection to the Internet. To provide further examples, network 160 may include wired telephone and cable hardware, satellite, cellular phone communication networks, internet gateways, modems, etc.

Customer interface device 102 may include a central processing unit (CPU) 104, a graphics processing unit (GPU) 106, a user interface 108, a memory 110, a display 114, and a communication unit 116. In the present aspect, customer channel interface device 102 may be implemented as a user equipment (UE), such as a mobile computing device, a computer, laptop, tablet, desktop, or any other suitable type of computing device.

CPU 104 and/or GPU 106 may be configured to communicate with memory 110 to store to, and read data from, memory 110. In accordance with the present aspects, CPU 104 and/or GPU 106 may be implemented as any suitable type of generic or application-specific processor. For example, CPU 104 may be implemented as one or more microprocessors configured to facilitate sending and/or receiving of data between customer interface device 102 and network 160 to perform one or more functions of the aspects as described herein.

In accordance with the present aspects, memory 110 may be a computer-readable non-transitory storage device that may include any combination of volatile (e.g., a random access memory (RAM), or a non-volatile memory (e.g., battery-backed RAM, FLASH, etc.)). Memory 110 may be configured to store instructions executable on CPU 104 and/or GPU 106. These instructions may include machine readable instructions that, when executed by CPU 104 and/or GPU 106, cause CPU 104 and/or GPU 106 to perform various acts.

User interface 108 may be configured to allow a user to interact with customer channel interface device 102. For example, user interface 108 may include a user-input device such as an interactive portion of display 114 (e.g., a “soft” keyboard displayed on display 114), an external hardware keyboard configured to communicate with customer channel interface device 102 via a wired or a wireless connection (e.g., a BLUETOOTH keyboard), an external mouse, or any other suitable user-input device.

Display 114 may be implemented as any suitable type of display and may facilitate user interaction with customer interface device 102 in conjunction with user interface 108. For example, display 114 may be implemented as a capacitive touch screen display, a resistive touch screen display, etc. In the present aspects, display 114 may be configured to work in conjunction with CPU 104 and/or GPU 106 to display reminder notifications and/or to facilitate other functionality in accordance with application module 112 as discussed herein.

Communication unit 116 may be configured to enable data communications between customer interface device 102 and claim application engine 170 via network 160. In the present aspect, communication unit 116 may be configured to send data to and receive data from client application engine 170 via network 160. For example, communication unit 116 may send information relevant for identifying the customer and his corresponding insurer profile from insurer profile database 184 (e.g., a user id), a type of insurance claim, an indication that one or more insurance claims have been opened, an indication that one or more action items have been completed, details associated with a customer's insurance policy entered by a customer via user interface 108, or any other suitable relevant information that may be used to generate action items, reminder notifications, and/or to update insurer profiles database 184.

To provide another example, communication unit 116 may be configured to receive claim status, action item status, reminder notifications, forms used to complete one or more action items, insurance policy information, etc., from claim application engine 170 via network 160, which may be displayed on customer interface device 102 via display 114, for example.

As will be appreciated by those of ordinary skill in the relevant art(s), communication unit 116 may be implemented with any suitable combination of suitable hardware and/or software to facilitate this functionality. For example, communication unit 116 may be implemented with any number of wired and/or wireless transceivers, network interfaces, physical layers (PHY), etc. In aspects in which customer interface device 102 is a mobile computing device, communication unit 16 may enable communications between customer interface device 102 and one or more mobile networks, which may or may not be part of network 160. For example, communication unit 116 may be configured to communicate with cellular and/or WLAN networks in addition to, or instead of, network 160. Networks separate from network 160 are not shown in FIG. 1 for purposes of brevity.

Application module 112 may be a portion of memory 110 configured to store instructions, that when executed by CPU 104 and/or GPU 106, cause CPU 104 and/or GPU 106 to enable user interface 108 to collect user input and/or to display feedback to a user in accordance with one or more applications and/or programs. For example, executable instructions stored in application module 112 may enable user interface 108 to display one or more prompts to a user and/or to accept user input, which may include entering data into one or more data fields, for example. In the present aspect, instructions stored in application module 112 may facilitate customer interface device 102 receiving reminder notifications, viewing claim status, etc.

In various aspects, application module 112 may enable user interface 108 to facilitate sending data to another device, such as client application engine 170, for example, by communication unit 116 sending data via network 160. For example, application module 112 may include instructions that enable user interface 108 to collect relevant data from a user and then allow the user to submit the relevant data to client application engine 170 by clicking or pressing an appropriate interactive button. For example, in conjunction with user interface 108, application module 112 may enable a user to enter a request to open one or more insurance claims and to send forms, information, or other data used to complete one or more open action items, to update one or more portions of her insurer profile stored in insurer profiles database 184, etc.

In some of the present aspects, application module 112 may include a full application that may be downloaded and/or installed on customer interface device 102. In accordance with such aspects, application module 112 may provide standalone application functionality, and may minimally utilize communications with client application engine 170 to collect customer information and/or to retrieve insurance policy details, claim status, action items, etc., from client application engine 170.

In other present aspects, application module 112 may be implemented as part of a thin client device, and may rely more heavily (i.e., as compared to full application aspects) on communications with client application engine 170 to collect customer information and/or to retrieve insurance policy details, claim status, action items, etc., from client application engine 170.

The present aspects of application module 112 may be utilized based upon a particular implementation of customer interface device 102. For example, if customer interface device 102 is implemented as a mobile computing device, then application module 112 may function as a mobile computing device application and may receive reminder notifications as push notifications or short messaging service (SMS) messages. To provide another example, if customer interface device 102 is implemented as a personal computing device, application module 112 may function as a web-browser that works in conjunction with a web-server to allow a user to view and/or update her insurer profile information that may be stored in insurer profiles database 184.

In the present aspect, claims associate interface device 140 and claims agent interface device 150 may have substantially similar structure, features, and functionality as customer interface device 102. Therefore, only differences between these devices will be further described.

In the present aspects, customer interface device 102, claims associate interface device 140, and claims agent interface device 150 may implement respective application modules that include the same level or a different level of application functionality. For example, customer interface device 102 may implement application module 112 as part of a thin client device, while claims associate interface device 140, and claims agent interface device 150 may implement respective application modules having standalone functionality.

In the present aspect, each of customer interface device 102, claims associate interface device 140, and claims agent interface device 150 may each access data stored in insurer profiles database 184. However, claims associate interface device 140 and/or claims agent interface device 150 may provide additional functionality based upon their particular implementation within action item generation system 100.

For example, claims associate interface device 140 may be operated by a claims associate within an insurance company. Therefore, claims associate interface device 140 may facilitate the authentication of a higher level of interaction with insurer profiles database 184 than customer interface device 102 and/or claims agent interface device 150. In the present aspects, this higher authorization level may facilitate a user operating claims associate interface device 140 to perform higher-level activities in conjunction with claim application engine 170, such as the initial creation of one or more action items, sending reminder notifications to a customer (e.g., to customer interface device 102), etc.

To provide another example, claims agent interface device 150 may be operated by a claims agent within an insurance company. Therefore, claims agent interface device 140 may facilitate the authentication of a higher level of interaction with insurer profiles database 184 than customer interface device 102. In the present aspects, this higher level of authorization may facilitate a user operating claims associate interface device 140 to perform higher-level activities in conjunction with claim application engine 170, such as verifying that one or more action items have been completed, receiving and processing documents sent in response to one or more open action items, etc.

Subtle variations may exist between one or more of each of customer interface device 102, claims associate interface device 140, and claims agent interface device 150 without departing the spirit and scope of the present disclosure. For example, claims associate interface device 140 and/or claims agent interface device 150 may incorporate additional application interface features that are not implemented by customer interface device 102. To provide illustrative examples, claims associate interface device 140 and/or claims agent interface device 150 may implement features specific to collecting insurer and/or claims data over each respective channel. This may include entry of information to appropriately identify the customer, entry of a customer account, an insurer employee secure login, etc.

Again, although the level of data access may vary based upon which of customer interface device 102, claims associate interface device 140, and/or claims agent interface device 150 may be communicating with claim application engine 170, the present aspects include each of customer interface device 102, claims associate interface device 140, and claims agent interface device 150 sending data to claim application engine 170, receiving data from claim application engine 170 (e.g., from insurer profiles database 184), and/or updating data stored in insurer profiles database 184.

Claim application engine 170 may include a communication unit 172, a CPU 174, and a memory 176. In the present aspect, claim application engine 170 may be implemented as any suitable type of server, such as an application server, a database server, a standalone sever, a web-based server, and/or as any suitable type of computing device, such as a computer, a smartphone, a laptop, a cloud-based computing device, etc.

In the present aspects, communication unit 172 may be configured to enable data communications between claim application engine 170 and one or more of customer interface device 102, claims associate interface device 140, and claims agent interface device 150 via network 160. Again, this data may include any suitable relevant information for identifying the customer and his corresponding insurer profile from insurer profiles database 184 (e.g., a user id), and may include information such as a type of insurance claim, an indication that one or more insurance claims have been opened, an indication that one or more action items have been completed, details associated with a customer's insurance policy, or any other suitable relevant information that may be used to generate action items, reminder notifications, update the status of action items, etc. This information may be sent, for example, from one or more of customer interface device 102, claims associate interface device 140, and/or claims agent interface device 150 via network 160.

In the present aspect, CPU 174 may be configured to communicate with memory 176 to store to and read data from memory 176. In accordance with the present aspects, memory 176 may be a computer-readable non-transitory storage device that may include any combination of volatile (e.g., a random access memory (RAM)), or non-volatile memory (e.g., battery-backed RAM, FLASH, etc.). Memory 176 may be configured to store instructions executable by CPU 174. These instructions may include machine readable instructions that, when executed by CPU 174, cause CPU 174 to perform various acts.

Data read/write module 178, action item assessment module 180, and data update module 182 are portions of memory 176 that may be configured to store instructions executable by CPU 174. In the present aspect, data read/write module 178 may include instructions that, when executed by CPU 174, causes CPU 174 to read data from and/or to write data to customer policy profiles database 184. Instructions stored in data read/write module 178 may facilitate suitable authorization and/or security protocols to identify, authorize, and/or restrict operations based upon the level of access of a user requesting access and/or modification to data stored in insurer profiles database 184.

For example, data read/write module 178 may include instructions to facilitate a claims associate and/or a claims agent managing generated action items via claims associate interface device 140 and/or claims agent interface device 150, respectively. To provide another example, data read/write module 178 may include instructions to facilitate an insured customer indicating that one or more generated action items have been completed via customer interface device 102 but restricting a customer from generating action items.

Management of action items may include, for example, a customer manually selecting action items that have been completed. As a result of authorization protocols implemented by data read/write module 178, this may result in a corresponding insurer profile stored in insurer profile database 184 being updated or the data being marked for subsequent validation by an insurance employee (e.g., a claims agent or claims associate).

To provide another example, management of action items may include an insurer employee (e.g., a claims agent or claims associate) editing an action item name or description, removing action items from an insurer profile, etc.

In the present aspect, data read/write module 178 may enable CPU 174 to receive one or more open claim requests via communication unit 172 and/or to identify the type of insurance claim associated with an open claim request. In the present aspect, data read/write module 178 may include instructions that, when executed by CPU 174, causes CPU 174 to work in conjunction with one or more of action item assessment module 180 and/or data update module 182 to modify data associated with one or more insurer profiles stored in insurer profiles database 184.

For example, once an indication is received that a status item has been completed, data read/write module 178 may cause CPU 174 to update the status of one or more action items associated with a particular insurer profile. To provide another example, once one or more documents are received that are used in conjunction with an action item, data read/write module 178 may cause CPU 174 to store the documents with a particular insurer profile in insurer profiles database 184.

In the present aspects, data read/write module 178 may include instructions to enable CPU 174 to query data from insurer profiles 184 and/or to store this data in any suitable portion of memory 176. Further in accordance with such aspects, data read/write module 178 may include instructions to enable CPU 174 to access stored data from memory 176 when executing instructions from action item assessment module 180 and/or from data update module 182.

In the present aspect, action item assessment module 180 may include instructions that, when executed by CPU 174, causes CPU 174 to determine a number and type of action items based upon a particular insurance claim type. In some aspects, this may be determined based upon data manually entered by an insurer employee, such as from a claims associate via claims associate interface device 140, for example.

In other aspects, the number and type of action items may be determined based upon CPU 174 determining the type of claim that is opened and associating the claim type with one or more corresponding action items in an automatic manner that does not require user intervention. To facilitate the generation of reminder notifications, as will be discussed below, the present aspects include instructions stored in action item assessment module 180 facilitating CPU 174 storing additional information with the generated set of action items. This additional information may include, for example, a date and/or time the claim was requested to be opened (or was actually opened), a date and/or time when each action item was created, a deadline or due date associated with when each of the generated action items is to be completed, etc.

To provide an illustrative example, if a claim is opened, action item assessment module 180 may receive a determination of a claim type via execution of instructions stored in data read/write module 178 by CPU 172. If this claim type corresponds to a car accident claim, for example, then action item assessment module 180 may include instructions that, when executed by CPU 174, facilitate the generation of a default set of action items associated with a car accident claim. These action items may include, for example, a customer taking and sending pictures of the vehicle damage, the customer writing, signing, and having notarized an affidavit, etc. A due date may also be generated associated with each action item, which may vary based upon the importance or urgency of each action item in the overall claim handling process.

To provide another example, if this claim type is a medical claim from a doctor's visit, surgery, etc., then action item assessment module 180 may include instructions that, when executed by CPU 174, facilitate the generation of a default set of action items associated with a medical claim. These action items may include, for example, a customer signing and returning a medical authorization form, etc.

To provide yet another example, if this claim type is a property loss claim from a theft, fire, etc., then action item assessment module 180 may include instructions that, when executed by CPU 174, facilitate the generation of a default set of action items associated with a property loss claim. These action items may include, for example, a customer signing and returning an itemized personal property inventory sheet, a power of attorney, etc.

In the present aspect, data update module 182 may include instructions that, when executed by CPU 174, cause CPU 174 to store and/or modify data that is part of one or more insurer profiles stored in insurer profiles database 184. For example, once CPU 174 determines a default set of action items associated with a particular type of insurance claim for an insurer, data update module 182 may include instructions that, when executed by CPU 174, facilitate writing these action items to a corresponding insurer profile stored in insurer profiles database 184 for a customer associated with the claim.

In the present aspect, action item assessment module 180 may include instructions that, when executed by CPU 174, facilitates the determination of whether one or more action items have been completed based upon data received via communication unit 172, for example. That is, once the number and type of action items are determined and associated with an insurer profile stored in insurer profile database 184, subsequent completion of one or more action items may be determined based upon data received via communication unit 172. This data may be submitted by an insured customer and/or from an insurance employee, for example, from one or more of customer interface device 102, claims associate interface device 140, and/or claims agent interface device 150 via network 160.

Once received, action item assessment module 180 may include instructions to match an associated insurer profile stored in insurer profile database 184 with information received from one or more of customer interface device 102, claims associate interface device 140, and/or claims agent interface device 150 via network 160. This matching process may be implemented using any suitable database entry matching system, such as looking up a customer identification number, login, last name and phone number, etc., contained within the received data.

In the present aspect, notification module 183 may include instructions that, when executed by CPU 174, facilitates the generation and/or sending of reminder notifications regarding action items that have not been completed.

In some of the present aspects, the generation and/or sending of reminder notifications may manually entered by an insurer employee, such as from a claims associate via claims associate interface device 140, for example.

In other aspects, the generation and/or sending of reminder notifications may be performed automatically without user intervention based upon one or more conditions. For example, a condition may include a due date passing associated with a generated action item. To provide another example, another condition may include a period of time passing from when the request to open the claim was received (or actually opened).

Upon passage of one or more due dates, instructions stored in notification module 183 may facilitate CPU 174 sending one or more notifications in accordance with a default insurer profile communication preference and/or with a communication preference set by the insurer and stored in his insurer profile in insurer profile database 184. For example, as will be further discussed below, one or more notifications may be sent to the customer via email, SMS, push notifications, etc.

In still other aspects, one or more notifications may be automatically generated and addressed to various people based upon the particular condition that has been satisfied. For example, as discussed above, the customer may be notified in various ways upon expiration of one or more action item due dates, expiration of a time period from when a claim was received or created, etc. However, if a customer has not responded to these notifications within a certain period of time (e.g., 1 week, two weeks, etc.) and/or a certain number of notifications have been generated (e.g., 2 or 3) then an insurance employee may be notified to follow up with the customer accordingly. For example, these types of notifications may include sending an email addressed to the insurance employee that may be received via interface device 140 and/or claims agent interface device 150.

In the present aspects, insurer profiles database 184 may be implemented as any suitable storage device configured to store data in any suitable number and type of data formats. Examples of data included in the insurer profiles stored in insurer profile database 184 may include insured contact information (e.g., names, mailing addresses, email addresses, etc.), insured user identification for access to the insured's profile (e.g., a user id), insurance information (e.g., policy types, policy numbers, coverage information, etc.) one or more action items, when each of the action items was generated, a due date for each of the one or more action items to be completed, a status of action items (whether each is completed or outstanding), communication preferences for the insured customer, etc.

Although insurer profiles database 184 is shown in FIG. 1 as a single device external to client application engine 170, insurer profile database 184 may be implemented within client application engine 170, separate from client application engine 170, or external to client application engine 170. Additionally or alternatively, insurer profiles database 184 may be implemented as any suitable number and/or types of storage devices.

Furthermore, FIG. 1 illustrates client application engine 170 coupled directly to insurer profile database 184 for purposes of brevity. As will be appreciated by those of ordinary skill in the relevant art(s), the present aspects of client application engine 170 may include client application engine 170 accessing insured profiles database 184 via any suitable network, which may include or be substantially similar to network 160, for example. In accordance with such aspects, client application engine 170 may be configured to access insured profiles database 184 via a network such that insured profile database 184 and client application engine 170 need not be co-located. For example, in accordance with such aspects, client application engine 170 may access insured profile database 184 via a connection to the Internet to download relevant customer information. To provide another example, client application engine 170 may access insured profile database 184 via a local, secure connection to one or more private servers to download relevant data.

Additionally, although illustrated as a single engine in FIG. 1, the present aspects include client application engine 170 implemented as any number or group of application engines. In accordance with such aspects, each application engine may include one or more CPUs and be configured to operate independently of the other application engines. Application engines operating as a group may process data sent from any suitable number of devices individually (e.g., based upon their availability) and/or concurrently (e.g., parallel processing). Application engines operating as a group may process data received from any suitable number of devices in a prioritized and/or distributed manner. For example, an operation associated with processing a request may be performed on one application engine while another operation associated with processing the same request (or a different request) is performed on another application engine.

Furthermore, in accordance with the present aspects, any of application module 112, data read/write module 178, action item assessment module 180, data update module 182, and/or notification module 183 may operate as a separately executable software application, a plugin that extends the functionality of another software application such as a web browser, an application programming interface (API) invokable by a software application, etc. The instructions included within any of application module 112, data read/write module 178, action item assessment module 180, data update module 182, and/or notification module 183 may be compiled and executable on their respective CPUs directly, or not compiled and interpreted by their respective CPUs on a runtime basis.

Implementation of action item generation system 100 may facilitate several technical advantages in conjunction with the various aspects described herein. For example, because claim application engine 170 may automate the reminder notification process, an insurance employee need not manually enter and send out these reminders, thereby saving network bandwidth usage. Furthermore, because the reminder notifications may be generated based upon a calculated schedule, network bandwidth may also be reduced as only necessary reminders are sent.

To provide another example, because claim application engine 170 may receive requests for claims and calculate a default set of action items as part of the insurer profiles stored in insurer profile database 184, the process of generating action items as part of an insurer profile may be streamlined. As a result, unnecessary and/or erroneous action items may be prevented from being associated with an open claim. This feature may advantageously reduce processor usage associated with one or more of claims associate interface device 140, claims agent interface device 150, and/or claim application engine 174. As an added benefit, the streamlining process may facilitate reducing the storage space allocated for one or more insurer profiles stored in insurer profiles database 184.

### II. Exemplary Screenshots for Viewing Profile Information

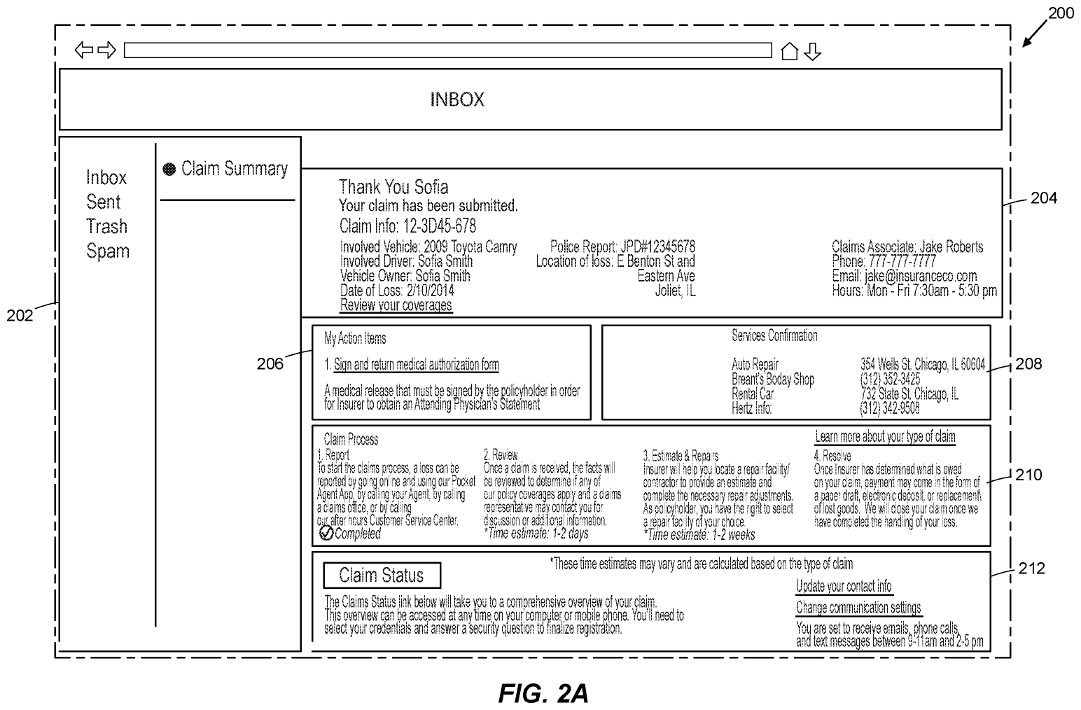

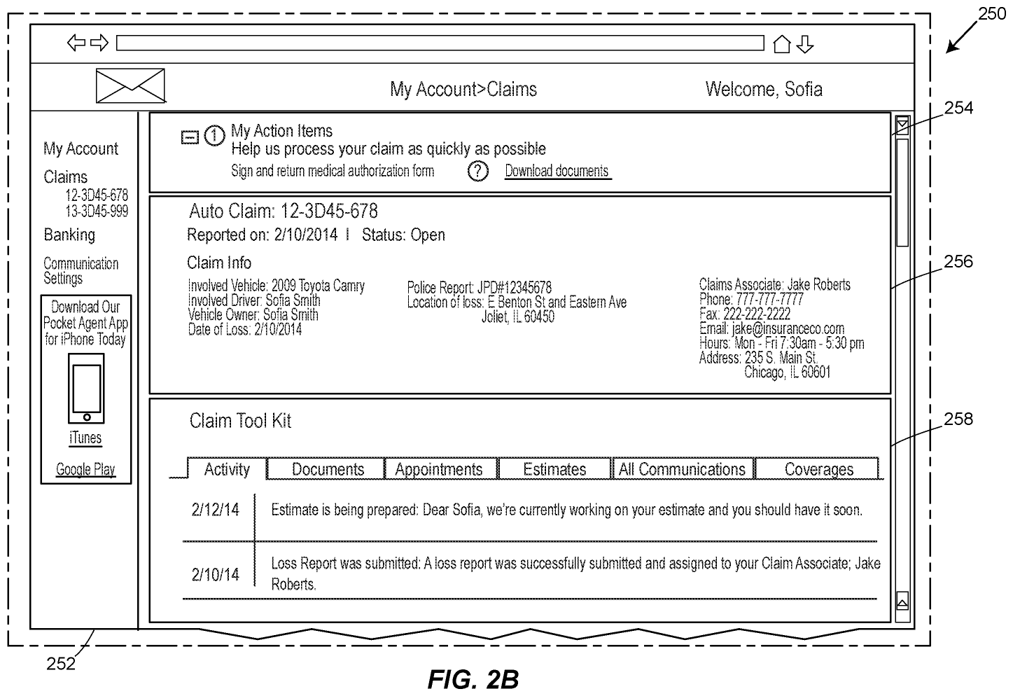

FIG. 2A is an exemplary screenshot 200 of an interactive email notification. Screenshot 200 may include portions 202, 204, 206, 208, 210, and 212. In the present aspect, upon submitting a request for a claim to be opened, a user may receive an email indicating details of the claim as shown in screenshot 200. In the present aspect, one or more portions 202, 204, 206, 208, 210, and/or 212 may be displayed using data received from a suitable computing device accessing an insurer's profile, such as claim application engine 170, for example, as shown in FIG. 1.

In the present aspects, the screenshot shown in FIG. 2A is an example of what may be displayed to a user once a client application (e.g., application module 112) is launched or otherwise executed on a customer interface device (e.g., customer interface device 102) in accordance with the various aspects as describe herein. In the present aspects, screenshot 200 may be displayed using any suitable interface device, such as display 114, for example, as shown in FIG. 1.

The example screenshots shown in FIGS. 2A-4B below are for illustrative purposes, and the functions described herein may be implemented using any suitable format and/or design without departing from the spirit and scope of the present disclosure. For example, the various portions discussed with reference to each of the following screenshots may include any suitable graphic, information, label, prompt, etc., to facilitate their respective functionality as described herein.

As shown in FIG. 2A, portion 202 illustrates a panel facilitating navigation of email folders. The email message to the right of portion 202 includes additional information regarding the customer's submitted claim.

Portion 204 includes a summary of the insurance claim and a confirmation that the claim has been submitted. For example, as shown in FIG. 2A, portion 204 includes a claim number (12-3D45-678), the location of the accident, the vehicles and drivers involved in the accident, contact numbers, the date of the accident, etc.

Portion 204 may include one or more interactive portions. For example, portion 204 includes the text “review your coverages” that may function as a uniform resource location (URL) link to open a webpage and provide the user with coverage information from her insurer profile. In the present aspects, a user clicking on this URL link may be presented with a new webpage requesting login credentials to allow a user to access this information (e.g., via insurer profiles database 184). The additional URL links discussed below may function in a similar manner, but may provide links to different webpages and/or provide alternative details or information as indicated.

Portion 206 may include one or more action items associated with the user's insurer profile that were generated when the claim was submitted (either manually or automatically). As shown in portion 206, the example action item listed is for a medical release form that needs to be signed by the insured and submitted to the insurer so an Attending Physician's statement may be obtained for use in the claim handling process. Portion 206 not only provides the user with a list of action items and their status, but may also provide a URL link to obtain one or more documents associated with this action item being completed. In this way, a user may quickly view the status of the action items and conveniently click the URL link at the same location to obtain the necessary information to complete them.

Portion 208 may include information relevant to the type of claim that has been filed. For example, in the case of the auto accident claim of FIG. 2, portion 208 may include contact information for auto shops, car rentals, etc.

Portion 210 may include information indicative of an overall claim process. As shown in FIG. 2, portion 210 may include a timeline or other similar graphic to indicate this progress. For example, portion 210 includes an indication that the initial report and claim has been submitted to the insurer, but that the additional steps of claim review, estimation and repairs, and resolution are still pending. Additionally or alternatively, portion 210 may include a time estimate for when each of these stages in the claim process may be expected to be completed (e.g., 1-2 days, 1-2 weeks, etc.) that is also displayed with each of the stages.

Portion 210 may also provide a URL link to obtain more information about the type of claim that has been filed. For example, a user may click this link to be directed to a webpage describing additional information about auto accident claims.

Portion 212 may include one or more interactive portions to enable a user to view the status of one or more submitted claims. For example, portion 212 may include an interactive label “claim status.” Upon selection of this interactive label, a user may be presented with additional claim status information, as discussed below with reference to FIG. 2B.

Additionally or alternatively, portion 212 may include one or more URL links to modify data associated with the user's insurer profile. For example, portion 212 includes two such links. The first link includes the text “update your contact info.” In the present aspect, a user may click on this link to modify contact information such as a name, mailing address, phone number, etc., associated with her insurer profile. The second link includes the text “change your communication settings.” A user may click on this link to set and/or change preferred modes of communication for receiving reminder notifications (e.g., email, SMS) or other types of communications (e.g., the claim response email communication shown in FIG. 2A), to set a preferred time of contact, etc.

FIG. 2B is an exemplary screenshot 250 of an interactive customer application providing claim status feedback. Screenshot 250 may include portions 252, 254, 256, and 258. In the present aspect, screenshot 250 is an example of what may be displayed upon a user selecting the “claim status” interactive label from portion 212, as shown in FIG. 2A. Again, in the present aspects, screenshot 250 may be displayed using any suitable interface device, such as display 114, for example, as shown in FIG. 1.

In the present aspect, one or more portions 252, 254, 256, and/or 258 may be displayed using data received from a suitable computing device accessing an insurer's profile, such as claim application engine 170 accessing an insurer profile from insurer profiles database 184, for example, as shown in FIG. 1.

As shown in FIG. 2B, portion 252 illustrates a navigation panel facilitating the navigation of various portions of an insurer's profile. Portion 252 may include various interactive links to facilitate a user viewing and/or modifying portions of the insurer's profile such as the user's account, pending open claims, payment information, communication settings, etc. In the present aspect, one or more links provided in portion 252 may provide similar or identical functionality as the URL links provided in screenshot 200. For example, a user may select the interactive link “communication settings” in portion 252 to open a target webpage address that may be the same address as the webpage opened when the link from portion 212 of FIG. 2A is selected including the text “change your communication settings.”

Similar to portion 206 of FIG. 2A, portion 254 may include one or more action items associated with the user's insurer profile that was generated when the claim was submitted (either manually or automatically). Although a single action item is shown in FIG. 2B, the present aspect may include any suitable number of action items being displayed in portion 254, which may be conveniently collapsed or expanded via selection of the interactive “-” symbol.

As shown in portion 254, the example action item is for a medical authorization form that needs to be signed by the insured and submitted to the insurer for use in the claim handling process. Portion 254 not only provides the user with a list of action items and their status, but once again may also provide a URL link to obtain one or more documents associated with this action item being completed (e.g., “download documents”). In this way, while a user is viewing a claim's status, the user may also quickly view the status of the action items and conveniently click the URL link at the same location to obtain the necessary information to complete them.

Similar to portion 204 of FIG. 2A, portion 256 may include a summary of the insurance claim and a confirmation that the claim has been submitted. For example, as shown in FIG. 2B, portion 256 includes a claim number (12-3D45-678), the location of the accident, the vehicles and drivers involved in the accident, contact numbers, the date of the accident, etc. In this way, while a user is viewing a claim's status, the user may also view a summary of the insurance claim.

Portion 258 may include information related to the status of the selected claim, in this case claim 12-3D45-678. Portion 258 may include a two-dimensional view that includes a vertically arranged timeline and horizontally arranged tabs corresponding to various claim information. For example, portion 258 may include dates and descriptions of activities corresponding to the selected claim. Upon a user selecting the various tabs (e.g., “documents,” “appointments,” etc.) portion 258 may change to display information associated with each respective tab. In the present aspect, this information may be accessed as part of the insurer's profile that is stored in insurer profile database 184.

### III. Exemplary Screenshots for Viewing and Sending Reminder Notifications

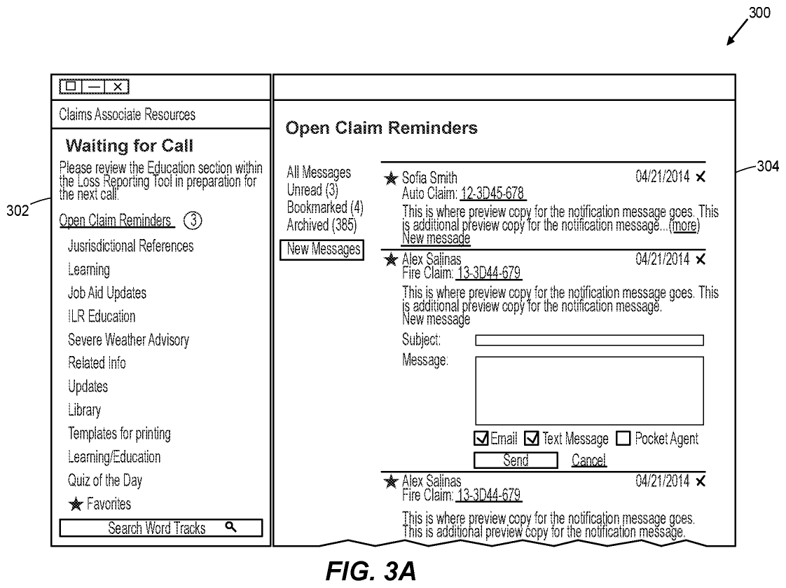

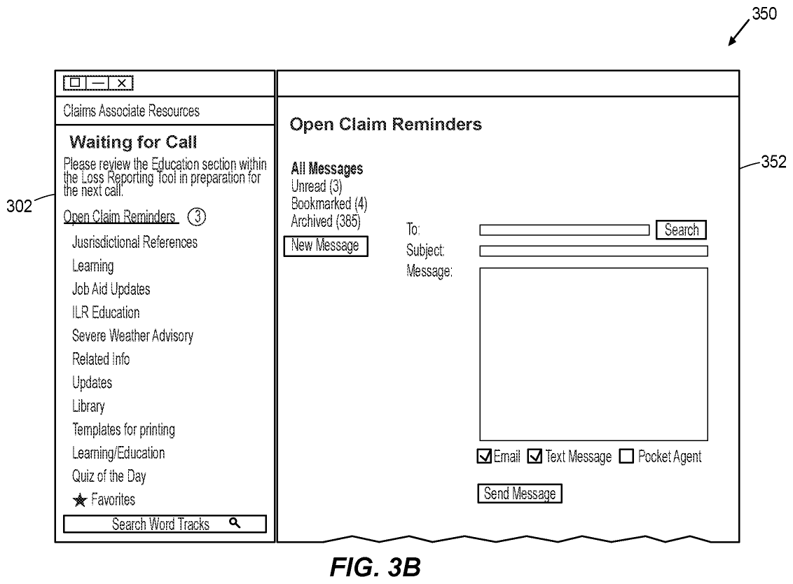

FIG. 3A is an exemplary screenshot 300 of an interactive insurer application facilitating the generation of action item reminder notifications. Screenshot 300 may include portions 302 and 304. In the present aspect, upon submitting a request for a claim to be opened, an insurance employee (e.g., a claim associate or claim agent) may receive a notification (e.g., via email) indicating that one or more claims have been submitted and are now pending.

In the present aspect, one or more portions 302 and/or 304 may be displayed using data received from a suitable computing device accessing an insurer's profile corresponding to the insurer whom submitted the claim request, such as claim application engine 170 accessing insurer profiles database 184, for example, as shown in FIG. 1. In the present aspects, the screenshot 300 shown in FIG. 3A is an example of what may be displayed using any suitable interface device, such as a display associated with claims agent interface device 150 and/or claims associate interface device 140, for example, as shown in FIG. 1.

As shown in FIG. 3A, portion 302 illustrates a panel facilitating navigation of one or more tools accessible to the insurance employee. As shown in FIG. 3A, the “open claim reminders” section is shown as being selected, thereby resulting in this window being displayed adjacent to portion 302 in portion 304. In the present aspects, the open claim reminders shown in portion 302 may be generated and sent to an insurance employee upon one or more conditions being met with respect to the generated action items, as previously discussed with reference to FIG. 1. For example, as due dates pass for one or more action items associated with open claims and/or a threshold number of notifications have been sent to the insured customer without one or more action items being acted on, a notification may be sent to the insurance employee. Once received, this may result in the total count (e.g., “3”) of queued open claim reminders for which the insurance employee should review being updated accordingly.

Portion 304 may display a window in accordance with the user's selection from portion 302, as previously discussed. For example, portion 304 may include a listing of open claim reminders to facilitate the generation of notifications to one or more insured customers that have open claims. Portion 304 may facilitate a user reviewing and verifying information associated with pending open claims. A user may then delete the reminder (e.g., if it is known to be already completed), bookmark the reminder notification for subsequent follow up, create a new notification manually, etc.

To provide an illustrative example, the first claim shown in portion 304 corresponds to auto claim 12-3D45-678, which also corresponds to the email previously discussed with reference to FIGS. 2A and 2B. In the present aspect, the insured customer Sofia Smith may initially submit the claim, which results in the action item being generated associated with a medical authorization form being submitted for assessment and having a corresponding deadline due date. Upon expiration of this due date (or upon a number of automatically generated reminder notifications being sent) the open claim reminder shown in portion 304 may be sent to the insurance employee.

FIG. 3B is an exemplary screenshot 350 of an interactive insurer application facilitating the sending of action item reminder notifications in accordance with an aspect of the present disclosure. Screenshot 350 may include portion 302, as shown in FIG. 3A, but also may include portion 352. In the present aspect, portion 352 may be displayed upon a user selecting an insured customer to send a reminder notification, in this case the insured customer corresponds to Sofia Smith, as previously discussed with reference to FIG. 3A.

Portion 352 may also enable a user to select the desired modes of communication in which to deliver the reminder notification. Portion 352 may include one or more checkboxes. In the present aspect, these checkboxes may be preselected using the preferred communications for the insured customer corresponding to that customer's insurer profile, as previously discussed with reference to FIG. 1. The present aspect includes a user modifying these checkboxes or maintaining the default selection as desired prior to sending the reminder notification.

Additionally or alternatively, one or more other fields included in portion 352 may be similarly prepopulated, for example, with one or more default selections. For example, the “to” field may be prepopulated with contact information from the insurer profile. To provide another example, the subject line and/or message field may be prepopulated with text based upon one or more factors, such as the claim type, a time period that has elapsed past the due date for one or more action items, a number of automated reminder notifications that have been sent to the insured resulting in the notification being sent to the insurance employee, the urgency or prioritization of the action item, etc. Once the fields in portion 352 are populated as desired, the user may send the message to the addressed recipient accordingly.

### IV. Exemplary Screenshots for Displaying Reminder Notifications and Action Item Feedback on a Mobile Device

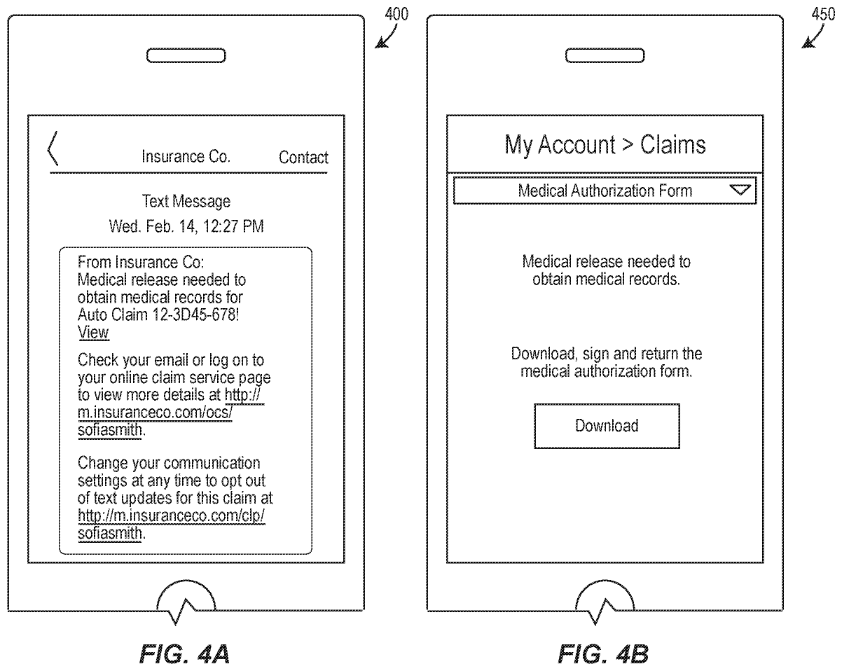

FIG. 4A is an exemplary screenshot 400 of an interactive customer application providing reminder notifications. In the present aspects, screenshot 400 is an example of what may be displayed on a customer interface device implemented as a mobile computing device, such as customer interface device 102, for example, as shown in FIG. 1.

In some of the present aspects, screenshot 400 may be displayed in response to a user (e.g., a claims agent or claims associate) generating and sending a reminder notification as previously shown and discussed with reference to FIGS. 3A and 3B. Referring back to FIG. 3B, screenshot 400 may be an example of a message sent by a user upon the fields in portion 352 being populated to include at least the “SMS” message checkbox.

In some of the other present aspects, screenshot 400 may be displayed in response to a suitable computing device (e.g., claim application engine 170) automatically generating and sending a reminder notification as previously shown and discussed with reference to FIG. 1. Again, a condition triggering the generation and sending of the text message shown in FIG. 4A may include a due date passing associated with a generated action item, a period of time passing from when the request to open the claim was received (or actually opened), etc.

As shown in FIG. 4A, the SMS message may include one or more interactive links, which are underlined. Similar to the interactive links previously discussed with respect to FIG. 2A, selection of the interactive links shown in FIG. 4A may navigate a user to a webpage or a particular screen within an application executed on mobile computing device 400 to access the relevant information. For example, selection of the “view” link in screenshot 400 may navigate a user to the claims section of her account, as shown in FIG. 4B, which is further discussed below. To provide additional examples, a user may select the relevant links to navigate to an online service claim page and/or a link to change communication settings.

FIG. 4B is an exemplary screenshot 450 of an interactive customer application providing reminder a link to a form used to complete the action item. In the present aspect, screenshot 450 includes a description of the action item, its corresponding status, and an interactive link to obtain one or more documents associated with this action item being completed. Similar to portion 206 as previously discussed with reference to FIG. 2A, a user may quickly view the status of the action item and conveniently click the interactive link at the same location to obtain the necessary information to complete it.

### V. Exemplary Method of an Insurance Quoting Application

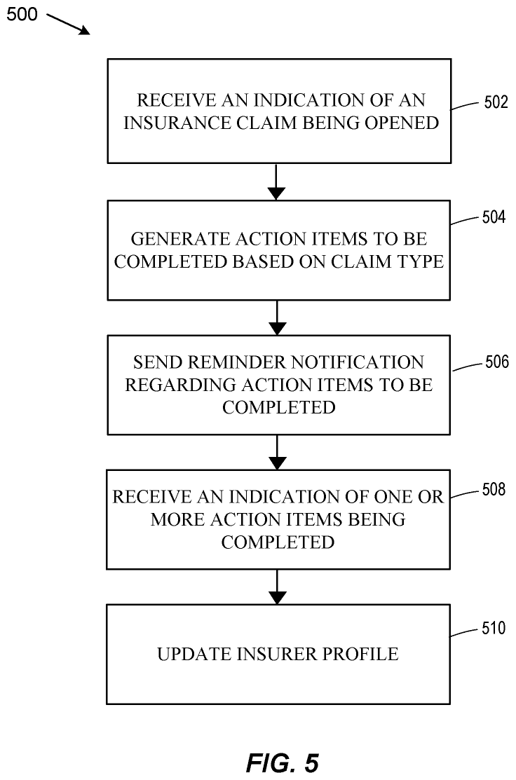

FIG. 5 illustrates a flow diagram of exemplary method 500 for maintaining an up-to-date insurer profile associated with an insurance policy. In the present aspect, method 500 may be implemented by any suitable device, such as claim application engine 170, for example, as shown in FIG. 1. In the present aspect, method 500 may be performed by one or more processors, applications, and/or routines, such as any suitable portion of CPU 174 executing instructions stored in one or more of data read/write module 178, action item assessment module 180, data update module 182, and/or notification module 183, for example, as shown in FIG. 1.

Method 500 may start when one or more processors receive a first indication of an insurance claim being opened (block 502). This first indication may include, for example, a request submitted by a user (e.g., an insured customer) that is received and/or forwarded to a suitable computing device (block 502). For example, claim application engine 170 may receive this request submitted via network 160 from a customer operating customer interface device 102. To provide another example, this indication may correspond to a customer requesting a claim be opened from a claim associate or claim agent via any suitable communication technique, who in turn may submits the request to open a claim from claims associate interface device 140 or claims agent interface device 150, respectively, to claim application engine 170 via network 160.

Method 500 may include one or more processors generating one or more action items to be completed in response to the first indication (block 504). These one or more action items may be generated based upon the type of insurance claim used for claim assessment (block 504). In the present aspects, these one or more action items may be generated automatically or manually based upon a default set of action items associated with the type of insurance claim (block 504).

Method 500 may include one or more processors sending a reminder notification to a computing device indicative of the one or more action items to be completed (block 506). This reminder notification may be sent from any suitable computing device, such as claim application engine 170, for example, as shown in FIG. 1 (block 506). This reminder notification may be generated automatically based upon one or more conditions being met, as previously discussed with reference to FIG. 1 (block 506).

Method 500 may include one or more processors receiving a second indication of one or more of the action items being completed (block 508). This second indication may include, for example, an indication associated with an insurer's profile submitted by a user associated with the insurer profile, (e.g., an insured customer) that is received and/or forwarded to a suitable computing device (block 508). For example, claim application engine 170 may receive this request via network 160 from a customer operating customer interface device 102. To provide another example, this indication may correspond to a customer informing a claim associate or claims agent via any suitable communication technique about the completion of one or more action items, who in turn may submit the indication of one or more action items being completed from claims associate interface device 140 or claims agent interface device 150, respectively, to claim application engine 170 via network 160.

Method 500 may include one or more processors updating an insurer profile indicating which of the one or more action items still need to be completed based upon the indication to generate an updated insurer profile (block 510). In the present aspect, the updated insurer profile may be accessed via a suitable computing device (e.g., claim application engine 170) to indicate information regarding a status of the claim (block 510). This may include, for example, CPU 174 executing one or more instructions stored in data update module 182, as discussed with reference to FIG. 1, for example, to facilitate this functionality (block 510).

### VI. Exemplary User Interfaces

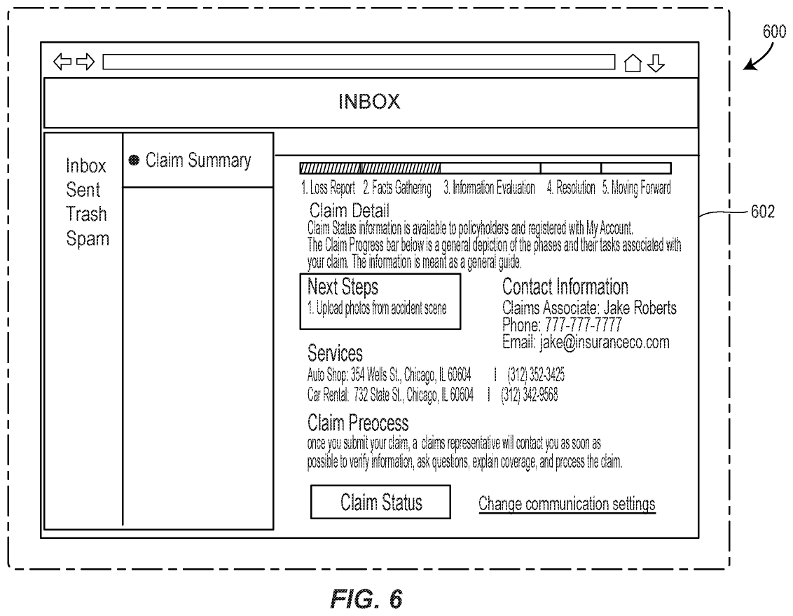

FIGS. 6-9 provide additional exemplary screenshots and/or user interfaces. FIG. 6 illustrates an exemplary screenshot 600 of an inbox associated with insurance claim reporting and processing. The user interface or screenshot 600 may be associated with sending a customer an email summary upon submission of a loss report. The user interface 600 may include claim progress tracker bar 602 at the top of the screen. The user interface 600 may also include several summaries or web-page sections (or boxes), such as the summaries or web-page sections shown related to “Claim Detail,” “Next Steps” (or My Action Items), “Contact Information,” “Services” “Claim Process,” and/or other summaries. The user interface 600 may also include a Claim Status icon or button, which may result in one or more claim-related statuses being displayed once it is clicked upon by a mouse.

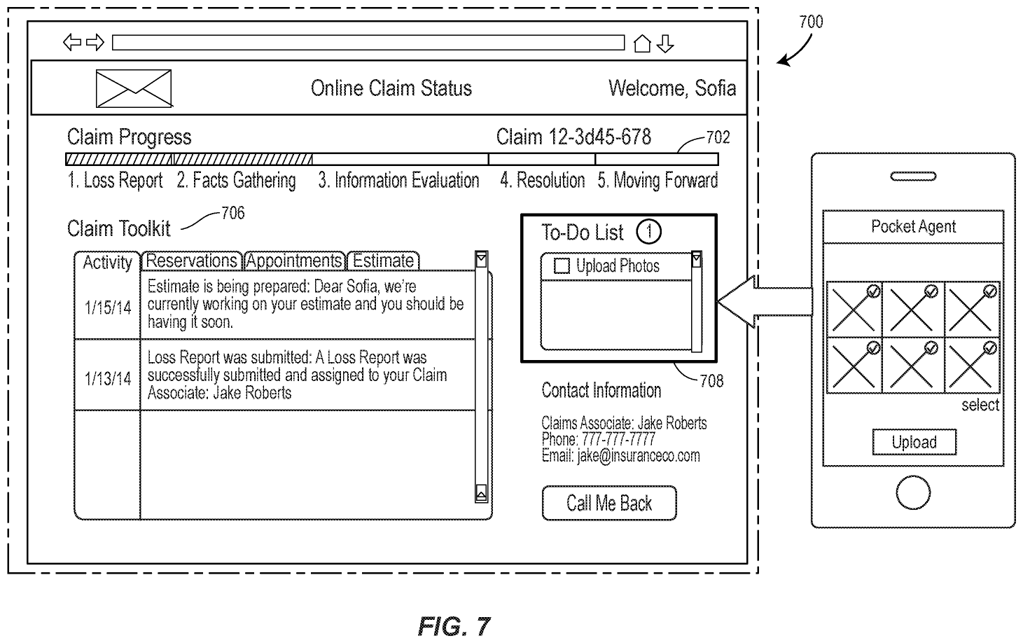

FIG. 7 illustrates an exemplary screenshot 700 associated with providing an online claim status and/or claim progress bar. The user interface or screenshot 700 may include the claim progress tracker bar 702. The claim progress tracker bar 702 may include several icons that make up or virtually represent the entire claim handling process, such as the icons shown related to “Loss Report,” “Facts Gathering,” “Information Evaluation,” “Resolution,” and/or “Moving Forward.” The user interface or screenshot 700 may also include a “Claim Toolkit” 706 that helps summarize information for the customer. The Claim Toolkit 708 may include the icons shown related to presenting information related to “Activity,” ‘Reservations,” “Appointments,” and/or “Estimates.” As shown, Activity related information may be associated with an Estimate and/or a Loss Report, and include a date and/or brief summary of that activity.

The user interface or screenshot 700 may also include a “To-Do List” (or My Action Items) 708 that lists action items associated with the insurance claim that a customer should complete to help facilitate the timely processing and/or handling of the insurance claim. For instance, an action item in the To-Do List may be to upload photos, such as photos of a damaged vehicle or home, and/or upload receipts or other documentation. As shown, a customer may be able to complete the To-Do List action item by using their mobile device. As an example, the customer may take photos of insured objects, receipts, or other documents via their mobile device and then upload them to the insurance provider's website. The user interface 700 may also include a Contact Information window or box, as shown, which may include contact information for a claim associate or insurance provider.

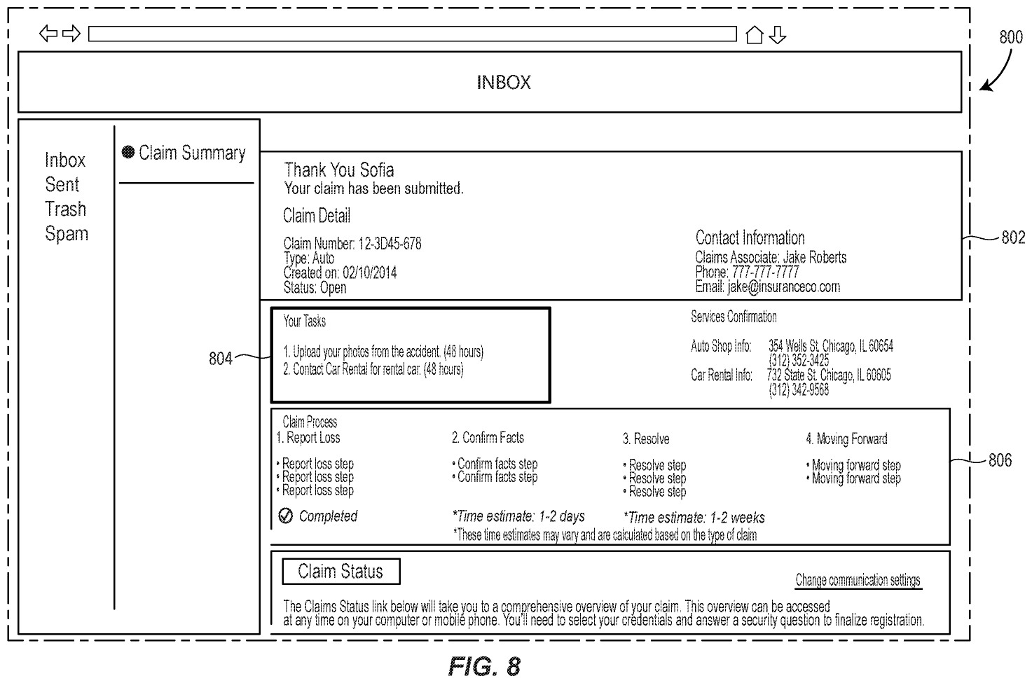

FIG. 8 illustrates an exemplary screenshot 800 of an inbox associated with insurance claim reporting and processing. The user interface or screenshot 800 may include several web-page sections (or areas), including a “Claim Detail” section 802; a “Your Tasks” (or My Action Items) section 804; and/or a “Claim Process” section 806.

The Claim Detail section 802 may include claim number, claim type, claim date, and/or claim status information. The Claim Detail section 802 may also include Contact Information for a claim associate or insurance provider.

The Your Task (or My Action Items) section 804 may include one or more actions items for the customer to complete. For instance, action items may relate to uploading photos of damaged/insured property, and/or contacting a rental car company about a rental car. A Service Confirmation section may also be provided. For instance, services related to towing companies, auto shops, and/or rental cars may be summarized.

The Claim Process section 806 may include a summary or information related to several steps in the claim handling process. “Report Loss,” “Confirm Facts,” “Resolve,” and/or “Moving Forward” sections and/or information may be provided or displayed.

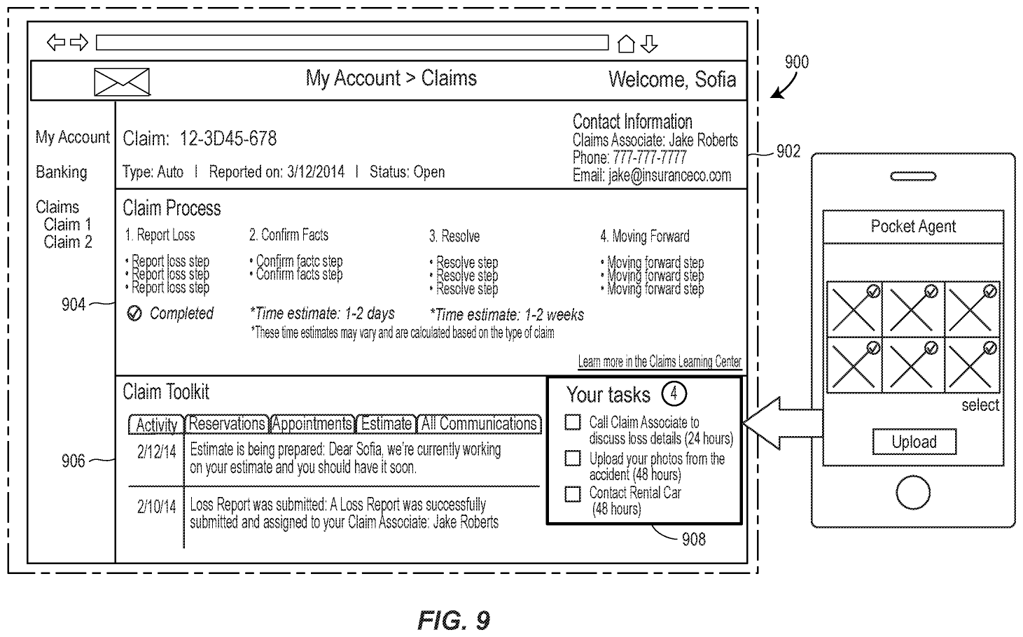

FIG. 9 illustrates an exemplary screenshot 900 associated with an insurance claim and claim process summary, and claim toolkit. The user interface or screenshot 900 may include a claim summary section 902, a “Claim Process” summary section 904; a “Claim Toolkit” section 906; and/or a “Your Tasks” (or My Action Items) section 908.

The claim summary section may include a claim identification number, a claim type, date reported, and/or claim status. The claim summary section may also include contact information for contacting the insurance provider.

The Claim Process section 904 may include “Report Loss,” “Confirm Facts,” “Resolve,” and/or “Moving Forward” sub-sections and/or related information. Each sub-section may have displayed a corresponding status, such as “completed,” or “Time estimate: 1-2 days.”

The Claim Toolkit section 906 may include several sub-sections, such as subsections related to Activity, Documents, Appointments, Estimate, and/or All Communications. Each sub-section may have an icon, and after a customer clicks upon that icon, a summary and/or information related to that sub-section may be retrieved, such as from a central insurance provider server, and then displayed, such as displayed on website or webpage accessed by the customer's mobile device.

The Your Tasks (or My Action Items) section 908 may include several tasks to be completed by the customer to move processing of the insurance claim along. For instance, action items for the insured to complete may include “Call Claim Associate,” “Upload Photos from Accident,” and/or “Contact Rental Car Company.” As shown, in one embodiment, the customer's action items may be self-checked as completed by the customer, such as by moving a cursor over a respective box and clicking a mouse. Other action items may be displayed, including those discussed elsewhere herein. For example, other actions items may include “Upload Receipts,” “Submit Receipts,” “Submit Doctor Information,” “Submit Medical Information,” “Submit Vehicle Information,” “Submit Driver Information,” “Submit Home Inventory Information,” “Submit POA,” and others.

The user interfaces 600, 700, 800, 900 may include additional, less, or alternate functionality, including that discussed elsewhere herein. The user interfaces may provide customer access to claim status and other claim information stored in a remote server associated with the insurance provider. The claim status and information may be remotely retrieved via a customer mobile device accessing the internet or an insurance provider website. The customer may learn of the Actions Items to be completed to process the claim via viewing the Action Items displayed, and/or by push notifications from the insurance provider to them detailing each Action Item as it comes due in the process.

### VII. Exemplary User Interfaces

In one aspect, an exemplary graphical user interface for handling and/or updating the status of an insurance claim is provided, such as depicted, in whole or in part, by FIG. 2A. The user interface may include (1) a claim summary section (“Claim Info”) providing claim number information and date information; (2) a customer action items list (“My Action Items”) detailing one or more action items to be completed by a customer to move handling and/or processing of the insurance claim along; and/or (3) a claim process or progress section (“Claim Process”) detailing at least one current status of the insurance claim such that by a customer accessing a website or webpage associated with the graphical user interface, the customer may take or perform needed customer actions to process the insurance claim, and/or that more efficient handling and/or processing of the insurance claim on the part of the insurance provider may be provided. The user interface may include additional, less, or alternate functionality, including that discussed elsewhere herein.

For instance, the one or more action items to be completed by a customer to move handling and/or processing of the insurance claim along (and that are displayed within the graphical user interface) may include: uploading photos; taking and/or uploading photos of a damaged vehicle or home; contacting an insurance provider; contacting a rental car company; contacting an towing company; contacting an auto shop; uploading estimates; uploading receipts; uploading other information; submitting forms, such as medical or POA forms; and/or other action items, including those discussed elsewhere herein.

The claim process or progress section detailing at least one current status of the insurance claim (and that are displayed within the graphical user interface) may include detailing a status of loss reporting, and/or a status of fact gathering or fact confirmation. Additionally or alternatively, the claim process or progress section detailing at least one current status of the insurance claim (and that are displayed within the graphical user interface) may include detailing a status of getting an estimate and/or resolving the insurance claim.

In another aspect, such as with respect to FIGS. 6 and/or 7, a graphical user interface for handling and/or updating the status of an insurance claim may be provided. The user interface may include (1) a claim process or progress section (“Claim Progress”) detailing the current status of the insurance claim; (2) a customer action items list (or “Next Steps” or My Action Items section) detailing one or more action items to be completed by a customer to move handling and/or processing of the insurance claim along; and/or (3) a claim toolkit section (“Claim Toolkit”) providing access to one or more summaries of insurance claim related activities, such that by a customer accessing a website or webpage associated with the graphical user interface, the customer may take or perform needed customer actions to process the insurance claim, and/or that more efficient handling and/or processing of the insurance claim on the part of the insurance provider may be provided. The user interface may include additional, less, or alternate functionality, including that discussed elsewhere herein.

For instance, the one or more action items to be completed by a customer to move handling and/or processing of the insurance claim along (and that are displayed within the graphical user interface) may include: uploading photos; taking and/or uploading photos of a damaged vehicle or home; contacting an insurance provider; contacting a rental car company; contacting an towing company; contacting an auto shop; uploading receipts, and/or other action items, including those discussed elsewhere herein.

The claim process or progress section detailing the current status of the insurance claim (and that is displayed within the graphical user interface) may include detailing a status of loss reporting, a status of fact gathering or fact confirmation, a status of information evaluation, a status of issue resolution; and/or a status of moving forward. The claim process or progress section detailing the current status of the insurance claim (and that are displayed within the graphical user interface) may additionally or alternatively include detailing a status of getting an estimate and/or resolving the insurance claim. The claim toolkit section may provide and/or display summaries of claim-related activity; one or more claim-related reservations; one or more claim-related appointments; and/or one or more claim-related estimates.

In another aspect, such as depicted with respect to FIG. 9, a graphical user interface for handling and/or updating the status of an insurance claim may be provided. The user interface may include (1) a claim summary section providing claim number information and date information; (2) a claim process or progress section (“Claim Process”) detailing one or more current statuses of the insurance claim; (3) a customer action items list (“Your Tasks” or My Action Items) detailing one or more action items to be completed by a customer to move handling and/or processing of the insurance claim along; and/or (4) a claim toolkit section (“Claim Toolkit”) providing access to one or more summaries of insurance claim-related activities, such that by a customer accessing a website or webpage associated with the graphical user interface, the customer may take or perform needed customer actions to process the insurance claim, and/or that more efficient handling and/or processing of the insurance claim on the part of the insurance provider may be provided. The user interface may include additional, less, or alternate functionality, including that disclosed elsewhere herein.

For example, the one or more action items to be completed by a customer to move handling and/or processing of the insurance claim along (and that are displayed within the graphical user interface) may include: uploading photos; taking and/or uploading photos of a damaged vehicle or home; contacting an insurance provider; contacting a rental car company; contacting an towing company; contacting an auto shop; uploading receipts; and/or other action items, including those discussed elsewhere herein.

The claim process or progress section detailing at least one current status of the insurance claim (and that are displayed within the graphical user interface) may include detailing a status of loss reporting, and/or a status of fact gathering or fact confirmation. The claim process or progress section detailing at least one current status of the insurance claim (and that are displayed within the graphical user interface) may additionally or alternatively include detailing a status of (i) getting an estimate, (ii) resolving the insurance claim, and/or (iii) moving forward with the insurance claim. The claim toolkit section may provide and/or display summaries and/or date information of claim-related activity; one or more claim-related reservations; one or more claim-related appointments; one or more claim-related estimates; and/or all communications related to the insurance claim.

In another aspect, such as with respect to FIG. 7, a graphical user interface for handling and/or updating the status of an insurance claim may be provided. The user interface may include: (1) a claim process or progress section (“Claim Progress”) detailing a current status of the insurance claim; (2) a customer action items list (or “To-Do List” or My Action Items) detailing one or more action items to be completed by a customer to move handling and/or processing of the insurance claim along; and/or (3) a claim toolkit section (“Claim Toolkit”) providing access to one or more summaries and dates of insurance claim-related activities, such that by a customer accessing a website or webpage associated with the graphical user interface, the customer may take or perform needed customer actions to process the insurance claim, and/or that more efficient handling and/or processing of the insurance claim on the part of the insurance provider may be provided. The user interface may include additional, less, or alternate functionality, including that disclosed elsewhere herein.

For example, the one or more action items to be completed by a customer to move handling and/or processing of the insurance claim along (and that are displayed within the graphical user interface) may include: uploading photos; taking and/or uploading photos of a damaged vehicle or home; contacting an insurance provider; contacting a rental car company; contacting an towing company; contacting an auto shop; uploading receipts; uploading forms; and/or other action items, including those discussed elsewhere herein.

In one aspect, an insurance provider remote server and/or electronic claim system may track the progress of an insurance claim; gather data; and/or generate actions items for the customer to complete. The remote server and/or electronic claim system may update one or more webpages associated with the customer's online or virtual account, such as by updating webpages to detail the current progress or status of the claim, and/or detail the outstanding action items to be completed by the customer. The remote server and/or electronic claim system may then send a push or electronic notification to the customer. The push notification may detail the action item. Additionally or alternatively, the push notification may ask the customer to login to their account at the insurance provider secure website. By accessing their online or virtual account, and/or by using the secure website, the customer may be able to view the action item in detail and/or complete the action item, such as upload photos or receipts. In one embodiment, the customer may login into their online or virtual account using a mobile device, such as a smart phone.

The claim process or progress section detailing the current status of the insurance claim (and that is displayed within the graphical user interface) may include detailing a status of loss reporting, a status of fact gathering or fact confirmation, a status of information evaluation, a status of issue resolution; and/or a status of moving forward. The claim toolkit section may provide and/or display summaries of claim-related activity; one or more claim-related reservations; one or more claim-related appointments; and/or one or more claim-related estimates.

### VIII. Exemplary Computer-Implemented Methods

In one aspect, a computer-implemented of handling and/or updating the status of an insurance claim may be provided. The method may include (1) receiving, at or by one or more processors, insurance claim information via wireless communication and/or data transmission from a mobile device (or other computing device) associated with a customer; (2) generating and/or updating, via the one or more processors, a claim summary section (of a user interface or webpage) providing claim number information and date information; (3) generating and/or updating, via the one or more processors, a customer action items list (for the user interface or webpage) detailing one or more action items to be completed by the customer to move handling and/or processing of the insurance claim along; (4) generating and/or updating, via the one or more processors, a claim process or progress section (for the user interface or webpage) detailing at least one current status of the insurance claim; (5) generating and/or updating, via the one or more processors, a user interface (or webpage) that includes and/or displays the (i) claim summary section, (ii) customer action list, and/or (iii) claim process or progress section; and/or (6) (a) transmitting, via the one or more processors, the user interface to the mobile device, and/or (b) otherwise causing, via the one or more processors, the user interface to be displayed on the mobile device (via wireless communication and/or data transmission) such that the customer may view the (i) claim summary section, (ii) customer action list, and/or (iii) claim process or progress section so that by the customer accessing a website or webpage associated with the graphical user interface and/or insurance provider, the customer may take or perform needed customer actions to process the insurance claim, and/or that more efficient handling and/or processing of the insurance claim on the part of the insurance provider may be provided. The method may include additional, fewer, or alternate actions, including those discussed elsewhere herein.

For example, the one or more action items to be completed by a customer to move handling and/or processing of the insurance claim along (and that are displayed within the graphical user interface) may include: uploading photos; taking and/or uploading photos of a damaged vehicle or home; contacting an insurance provider; contacting a rental car company; contacting an towing company; contacting an auto shop; uploading receipts; uploading medical, legal, or other forms; and/or other action items, including those discussed elsewhere herein.

The claim process or progress section detailing at least one current status of the insurance claim (and that are displayed within the graphical user interface) may include detailing a status of loss reporting, and/or a status of fact gathering or fact confirmation. Additionally or alternatively, the claim process or progress section detailing at least one current status of the insurance claim (and that are displayed within the graphical user interface) may include detailing a status of getting an estimate and/or resolving the insurance claim.

In another aspect, a computer-implemented for handling and/or updating the status of an insurance claim may be provided. The method may include (1) receiving, at or by one or more processors, insurance claim information via wireless communication and/or data transmission from a mobile device (or other computing device) associated with a customer; (2) generating and/or updating, via the one or more processors, a claim process or progress section (of a user interface or webpage) detailing the current status of the insurance claim; (3) generating and/or updating, via the one or more processors, a customer action items list (for the user interface or webpage) detailing one or more action items to be completed by a customer to move handling and/or processing of the insurance claim along; (4) generating and/or updating, via the one or more processors, a claim toolkit section (for the user interface or webpage) providing access to one or more summaries of insurance claim-related activities; (5) generating and/or updating, via the one or more processors, a user interface (or webpage) that includes and/or displays the (i) claim process or progress section, (ii) customer action list, and/or (iii) claim toolkit section; and/or (6) (a) transmitting, via the one or more processors, the user interface to the mobile device via wireless communication and/or data transmission, and/or (b) otherwise causing, via the one or more processors, the user interface to be displayed on the mobile device such that the customer may view the (i) claim process or progress section, (ii) customer action list, and/or (iii) claim toolkit section so that by the customer accessing a website or webpage associated with the graphical user interface and/or insurance provider, the customer may take or perform needed customer actions to process the insurance claim, and/or that more efficient handling and/or processing of the insurance claim on the part of the insurance provider may be provided. The method may include additional, fewer, or alternate actions, including those discussed elsewhere herein.

For example, the one or more action items to be completed by a customer to move handling and/or processing of the insurance claim along (and that are displayed within the graphical user interface) may include: uploading photos; taking and/or uploading photos of a damaged vehicle or home; contacting an insurance provider; contacting a rental car company; contacting an towing company; contacting an auto shop; uploading receipts; uploading medical, legal, or other forms; and/or other action items, including those discussed elsewhere herein.

The claim process or progress section detailing the current status of the insurance claim (and that is displayed within the graphical user interface) may include detailing a status of loss reporting, a status of fact gathering or fact confirmation, a status of information evaluation, a status of issue resolution; and/or a status of moving forward. Additionally or alternatively, the claim process or progress section detailing the current status of the insurance claim (and that are displayed within the graphical user interface) may include detailing a status of getting an estimate and/or resolving the insurance claim. The claim toolkit section may provide and/or display summaries of claim-related activity; one or more claim-related reservations; one or more claim-related appointments; and/or one or more claim-related estimates.

In another aspect, a computer-implemented method for handling and/or updating the status of an insurance claim may be provided. The method may include (1) receiving, at or by one or more processors, insurance claim information via wireless communication and/or data transmission from a mobile device (or other computing device) associated with a customer; (2) generating and/or updating, via the one or more processors, a claim summary section (of a user interface or webpage) providing claim number information and date information; (3) generating and/or updating, via the one or more processors, a claim process or progress section (for the user interface or webpage) detailing one or more current statuses of the insurance claim; (4) generating and/or updating, via the one or more processors, a customer action items list (for the user interface or webpage) detailing one or more action items to be completed by a customer to move handling and/or processing of the insurance claim along; (5) generating and/or updating, via the one or more processors, a claim toolkit section (for the user interface or webpage) providing access to one or more summaries of insurance claim-related activities; (6) generating and/or updating, via the one or more processors, a user interface (or webpage) that includes and/or displays the (i) claim summary section, (ii) claim process or progress section, (iii) customer action list, and/or (iv) claim toolkit section; and/or (7) (a) transmitting, via the one or more processors, the user interface to the mobile device via wireless communication and/or data transmission, and/or (b) otherwise causing, via the one or more processors, the user interface to be displayed on the mobile device such that the customer may view the (i) claim summary section, (ii) claim process or progress section, (iii) customer action list, and/or (iv) claim toolkit section so that by the customer accessing a website or webpage associated with the graphical user interface and/or insurance provider, the customer may take or perform needed customer actions to process the insurance claim, and/or that more efficient handling and/or processing of the insurance claim on the part of the insurance provider may be provided. The method may include additional, fewer, or alternate actions, including those discussed elsewhere herein.

For example, the one or more action items to be completed by a customer to move handling and/or processing of the insurance claim along (and that are displayed within the graphical user interface) may include: uploading photos; taking and/or uploading photos of a damaged vehicle or home; contacting an insurance provider; contacting a rental car company; contacting an towing company; contacting an auto shop; uploading receipts or forms; and/or other action items, including those discussed elsewhere herein.

The claim process or progress section detailing at least one current status of the insurance claim (and that are displayed within the graphical user interface) may include detailing a status of loss reporting, and/or a status of fact gathering or fact confirmation. Additionally or alternatively, the claim process or progress section detailing at least one current status of the insurance claim (and that are displayed within the graphical user interface) may include detailing a status of (i) getting an estimate, (ii) resolving the insurance claim, and/or (iii) moving forward with the insurance claim. The claim toolkit section may provide and/or display summaries of claim-related activity; one or more claim-related reservations; one or more claim-related appointments; one or more claim-related estimates; and/or all communications related to the insurance claim.

In another aspect, a computer-implemented method for handling and/or updating the status of an insurance claim. The method may include (1) receiving, at or by one or more processors, insurance claim information via wireless communication and/or data transmission from a mobile device (or other computing device) associated with a customer; (2) generating and/or updating, via the one or more processors, a claim process or progress section (of a user interface or webpage) detailing a current status of the insurance claim; (3) generating and/or updating, via the one or more processors, a customer action items list (for the user interface or webpage) detailing one or more action items to be completed by a customer to move handling and/or processing of the insurance claim along; (4) generating and/or updating, via the one or more processors, a claim toolkit section (for the user interface or webpage) providing access to one or more summaries of insurance claim-related activities; (5) generating and/or updating, via the one or more processors, a user interface (or webpage) that includes and/or displays the (i) claim process or progress section, (ii) customer action list, and/or (iii) claim toolkit section; and/or (6) (a) transmitting, via the one or more processors, the user interface to the mobile device via wireless communication and/or data transmission, and/or (b) otherwise causing, via the one or more processors, the user interface to be displayed on the mobile device such that the customer may view the (i) claim process or progress section, (ii) customer action list, and/or (iii) claim toolkit section so that by the customer accessing a website or webpage associated with the graphical user interface and/or insurance provider, the customer may take or perform needed customer actions to process the insurance claim, and/or that more efficient handling and/or processing of the insurance claim on the part of the insurance provider may be provided. The method may include additional, fewer, or alternate actions, including those discussed elsewhere herein.

For example, the one or more action items to be completed by a customer to move handling and/or processing of the insurance claim along (and that are displayed within the graphical user interface) may include: uploading photos; taking and/or uploading photos of a damaged vehicle or home; contacting an insurance provider; contacting a rental car company; contacting an towing company; contacting an auto shop; uploading receipts or forms; and/or other action items, including those discussed elsewhere herein.

The claim process or progress section detailing the current status of the insurance claim (and that is displayed within the graphical user interface) may include detailing a status of loss reporting, a status of fact gathering or fact confirmation, a status of information evaluation, a status of issue resolution; and/or a status of moving forward. The claim toolkit section may provide and/or display summaries of claim-related activity; one or more claim-related reservations; one or more claim-related appointments; and/or one or more claim-related estimates.

### IX. Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain aspects are described herein as including logic or a number of components or modules. Modules may constitute either software modules (e.g., code stored on a machine-readable medium) or hardware modules. A hardware module is tangible unit capable of performing certain operations and may be configured or arranged in a certain manner. In example aspects, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In some cases, a hardware module may include dedicated circuitry or logic that is permanently configured (e.g., as a special-purpose processor, such as a field programmable gate array (FPGA) or an application-specific integrated circuit (ASIC)) to perform certain operations. A hardware module may also include programmable logic or circuitry (e.g., as encompassed within a general-purpose processor or other programmable processor) that is temporarily configured by software to perform certain operations. It will be appreciated that the decision to implement a hardware module in dedicated and permanently configured circuitry or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering aspects in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In aspects in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example aspects, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example aspects, the processor or processors may be located in a single location (e.g., within a home environment, an office environment or as a server farm), while in other aspects the processors may be distributed across a number of locations.

The one or more processors may also operate to support performance of the relevant operations in a “cloud computing” environment or as a SaaS. For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example aspects, the one or more processors or processor-implemented modules may be located in a single geographic location (e.g., within a home environment, an office environment, or a server farm). In other example aspects, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one aspect” or “an aspect” means that a particular element, feature, structure, or characteristic described in connection with the aspect is included in at least one aspect. The appearances of the phrase “in one aspect” in various places in the specification are not necessarily all referring to the same aspect.

Some aspects may be described using the expression “coupled” and “connected” along with their derivatives. For example, some aspects may be described using the term “coupled” to indicate that two or more elements are in direct physical or electrical contact. The term “coupled,” however, may also mean that two or more elements are not in direct contact with each other, but yet still co-operate or interact with each other. The aspects are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, condition A or B is satisfied by any one of the following: A is true (or present) and B is false (or not present), A is false (or not present) and B is true (or present), and both A and B are true (or present).

In addition, use of the “a” or “an” are employed to describe elements and components of the aspects herein. This is done merely for convenience and to give a general sense of the description. This description should be read to include one or at least one and the singular also includes the plural unless it is obvious that it is meant otherwise.

Upon reading this disclosure, those of ordinary skill in the art will appreciate still additional alternative structural and functional designs for providing an interface to generate action items associated with an insurance claim assessment process and to maintain a status of the action items through the disclosed principles herein. Thus, while particular aspects and applications have been illustrated and described, it is to be understood that the disclosed aspects are not limited to the precise construction and components disclosed herein. Various modifications, changes and variations may be made in the arrangement, operation and details of the method and apparatus disclosed herein without departing from the spirit and scope defined in the appended claims. The methods and processes described throughout the present disclosure may be utilized to generate action items, generate reminder notifications, and/or update an insurer profile in conjunction with an insurance claim process or any other suitable purpose.

Also, the patent claims at the end of this patent application are not intended to be construed under 35 U.S.C. § 112(f) unless traditional means-plus-function language is expressly recited, such as “means for” or “step for” language being explicitly recited in the claim(s).

1. A computer-implemented method for maintaining an up-to-date insurer profile associated with an insurance policy, comprising:
receiving, by one or more processors, a first indication of an insurance claim being opened;
generating, by one or more processors, one or more action items to be completed in response to the first indication, the one or more action items being based upon the type of insurance claim used for claim assessment;
sending, by one or more processors, a reminder notification to a computing device indicative of the one or more action items to be completed, wherein the reminder notification includes one or more uniform resource location (URL) links to one or more corresponding document forms for completing the one or more action items;
receiving, by one or more processors, a second indication of an action item from the one or more action items being completed; and
updating, by one or more processors, an insurer profile indicating which of the one or more action items still need to be completed based upon the second indication to generate an updated insurer profile,
wherein the updated insurer profile is accessed via the computing device to indicate information regarding status of the claim.

2. The computer-implemented method of claim 1, wherein the insurer profile includes information selected from the group consisting of:
customer information;
a type of insurance claim;
status; and
a preferred channel of communications with the customer.

3. The computer-implemented method of claim 1, wherein the claim status is based upon which of the one or more action items have been completed and which of the one or more action items still need to be completed.

4. The computer-implemented method of claim 1, wherein the computing device is a mobile computing device, and
wherein the act of sending the reminder notification to the mobile computing device comprises:
sending the notification to the mobile computing device as a push notification.

5. The computer-implemented method of claim 1, wherein
the reminder notification includes one or more uniform resource location (URL) links to one or more of:
the updated insurer profile.

6. The computer-implemented method of claim 1, wherein the act of sending the reminder notification comprises:
sending the reminder notification automatically without user intervention after an expiration of a time period from when the first indication of the insurance claim being opened was received.

7. The computer-implemented method of claim 2, wherein the act of sending the reminder notification comprises:
sending the reminder notification to the computing device in accordance with the preferred channel as indicated in the customer insurance profile.

8. The computer-implemented method of claim 7, wherein the preferred channel of communications includes one or more of:
short message service (SMS); or
e-mail.

9. A method for displaying a graphical user interface depicting status of an insurance claim and allowing a customer to interact therewith, comprising:
displaying, on a user interface, a claim summary portion providing claim number information and date information based upon the insurance claim;
displaying, on the user interface, a customer action items list portion including (i) a list of one or more action items to be completed by a customer so that the insurance claim process may be completed, and (ii) one or more interactive links to documents to be submitted to the insurer in accordance with the respective one or more action items, wherein the one or more interactive links to documents correspond to document forms for completing the one or more action items; and
displaying, on the user interface, a claim process portion detailing a current status of the insurance claim, wherein the current status is updated based upon the customer completing the one or more action items.

10. The method of claim 9, wherein the one or more action items include an action item selected from the group consisting of:
uploading photos;
taking photos of a damaged vehicle;
taking photos of a damaged home;
uploading photos of a damaged vehicle;
uploading photos of a home;
contacting an insurance provider;
contacting a rental car company;
contacting an towing company;
contacting an auto shop;
uploading receipts; and
uploading medical or legal forms.

11. The method of claim 9, wherein the claim process portion includes a status selected from the group consisting of:
loss reporting;
fact gathering;
fact confirmation;
information evaluation;
issue resolution;
a repair estimate; and
insurance claim resolution.

12. The method of claim 9, further comprising:
a claim status interactive link, whereupon being selected by the customer, the graphical user interface displays a claim toolkit portion.

13. The method of claim 12, wherein the claim toolkit portion includes information selected from the group consisting of:
one or more summaries of claim-related activity;
one or more claim-related reservations;
one or more claim-related appointments; and
one or more claim-related estimates.

14. The method of claim 9, wherein the one or more interactive links included in the customer action items list are uniform resource location (URL) links.

15. A non-transitory, tangible computer-readable medium storing machine readable instructions displaying an interactive graphical user interface that, when executed by a processor, cause the processor to:
display a claim summary portion providing claim number information and date information based upon the insurance claim;
display a customer action items list portion including (i) a list of one or more action items to be completed by a customer so that the insurance claim process may be completed, and (ii) one or more interactive links to documents to be submitted to the insurer in accordance with the respective one or more action items, wherein the one or more interactive links to documents correspond to document forms for completing the one or more action items; and
display a claim process portion detailing a current status of the insurance claim, wherein the current status is updated based upon the customer completing the one or more action items.

16. The non-transitory, tangible computer-readable medium of claim 15, wherein the instructions to display the customer action items list portion include instructions to display one or more action items selected from the group consisting of:
uploading photos;
taking photos of a damaged vehicle;
taking photos of a damaged home;
uploading photos of a damaged vehicle;
uploading photos of a home;
contacting an insurance provider;
contacting a rental car company;
contacting an towing company;
contacting an auto shop;
uploading receipts; and
uploading medical or legal forms.

17. The non-transitory, tangible computer-readable medium of claim 15, wherein the instructions to display the customer action items list portion include instructions to display a status selected from the group consisting of:
loss reporting;
fact gathering;
fact confirmation;
information evaluation;
issue resolution;
a repair estimate; and
insurance claim resolution.

18. The non-transitory, tangible computer-readable medium of claim 15, further including instructions that, when executed by a processor, cause the processor to:
display a claim status interactive link, whereupon being selected by the customer, the graphical user interface displays a claim toolkit portion.

19. The non-transitory, tangible computer-readable medium of claim 18, wherein the instructions to display the claim toolkit portion include instructions to display information selected from the group consisting of:
one or more summaries of claim-related activity;
one or more claim-related reservations;
one or more claim-related appointments; and
one or more claim-related estimates.

20. The non-transitory, tangible computer-readable medium of claim 15, wherein the one or more interactive links included in the customer action items list are uniform resource location (URL) links.
